(19) United States
(12) Patent Application Publication
(10) Pub. No.: US 2010/0048083 A1
(43) Pub. Date: Feb. 25, 2010

(54) METHOD OF MANUFACTURING SPARK PLUG

(75) Inventors: Tsutomu Shibata, Aichi (JP); Hoju Fukushima, Aichi (JP)

Correspondence Address: KUSNER & JAFFE;HIGHLAND PLACE SUITE 310, 6151 WILSON MILLS ROAD, HIGHLAND HEIGHTS, OH, 44143, US

(73) Assignee: NGK SPARK PLUG CO., LTD.

(21) Appl. No.: 12/539,850

(22) Filed: Aug. 12, 2009

(30) Foreign Application Priority Data
Aug. 19, 2008 (JP) JP 2008-210229

(51) Int. Cl. H01T 21/02

(52) U.S. Cl. 445/7

(57) ABSTRACT

A process for forming a glass seal layer in a spark plug, comprising an inserting step of inserting a terminal electrode into an axial hole in an insulator, a hot compression step of pushing the terminal electrode in a heated state to thereby compress the glass powder mixture, and a cooling step of performing cooling to thereby form the glass seal layer.

### FIELD OF THE INVENTION

The present invention relates to a method of manufacturing a spark plug used for an internal combustion engine.

### BACKGROUND OF THE INVENTION

A spark plug is attached to an internal combustion engine (engine) and used to ignite a gas mixture within a combustion chamber. In general, as shown in FIG. 1, a spark plug includes an insulator 2 formed of ceramic such as alumina and having an axial hole 4; a metallic shell 3 provided around the insulator 2; and a center electrode 5 inserted into a front end portion of the axial hole 4. Further, a terminal electrode 6 formed of metal is provided at the rear end side of the insulator 2. Specifically, the terminal electrode 6 includes a terminal portion 6A which has a relatively large diameter and to which a plug cap (not shown) or the like is attached, and an extending portion 6B extending frontward from the terminal portion 6A. The terminal electrode 6 is provided in a state where the terminal portion 6A is in contact with a rear end surface 2A of the insulator 2 and the extending portion 6B is inserted into a rear end portion of the axial hole 4. Further, a glass seal layer 7 is formed in the axial hole 4 so as to fix the center electrode 5 and the terminal electrode 6 to the insulator 2 in a sealed condition.

In general, the glass seal layer 7 is formed through hot press processing as described below. That is, after the center electrode 5 is placed in the front end portion of the axial hole 4, a glass powder mixture containing glass powder is charged into the axial hole 4. Then, in a heated state, the terminal electrode 6 is pushed into the axial hole 4 from its rear end to thereby compress the glass powder mixture. After that, by means of cooling, the softened glass powder solidifies, whereby the glass seal layer 7 is formed (see, for example, Japanese Patent No. 3813708).

In recent years, a problem has been noted, namely, that, after the above-described hot press processing, the terminal electrode 6 is fixed in a state where the terminal portion 6A of the terminal electrode 6 is not in contact with the rear end surface 2A of the insulator 2 (a state where the terminal portion 6A is lifted, i.e., separated, from the rear end surface 2A) as shown in FIG. 5. Conceivably, this problem of “lifting” is caused by a stress which remains within the glass powder mixture due to compression of the glass powder mixture. The present inventors have carried out keen studies on this point and have found that the following two factors especially increase the residual stress. The first factor is use of an insulator 2 whose axial hole 4 has a relatively small diameter (that is, the glass seal layer 7 has a relatively small outer diameter) in order to meet the recent demand for reduction of the diameter of a spark plug. The second factor is an increase in the pushing speed of the terminal electrode 6 for improving production efficiency. In particular, through further studies, the present inventors have found that, when the maximum outer diameter of the glass seal layer 7 is equal to or less than a predetermined diameter and the pushing speed of the terminal electrode 6 is equal to or greater than a predetermined speed, there may be produced a residual stress strong enough to cause the terminal electrode 6 to lift from the insulator 2.

The present invention has been accomplished in view of the foregoing. An advantage of the present invention is a method of manufacturing a spark plug which more reliably prevents lifting of the terminal electrode from the insulator even when the terminal electrode is pushed at a predetermined speed or higher so as to perform hot press processing to thereby form a glass seal layer whose maximum outer diameter is a predetermined diameter or less.

### SUMMARY OF THE INVENTION

Hereinbelow, configurations suitable for achieving the above-described advantage will be described in an itemized fashion. Notably, when necessary, action and effects peculiar to each configuration will be added.

Configuration 1. In accordance with the present invention, there is provided a method of producing a spark plug which comprises

an insulator having an axial hole which extends through the insulator in an axial direction;

a center electrode provided in a front end portion of the axial hole;

a terminal electrode provided in a rear end portion of the axial hole; and

a glass seal layer formed of a glass powder mixture containing glass powder and providing a seal within the axial hole at least between the terminal electrode and the insulator, the glass seal layer having a maximum outer diameter of 4 mm or less, the method comprising:

a disposing step of disposing the center electrode within the axial hole;

a charging step of charging the glass powder mixture into the axial hole;

an inserting step of inserting the terminal electrode into the axial hole;

a hot compression step of pushing the terminal electrode in a heated state so as to compress the glass powder mixture; and

a cooling step of cooling the glass powder mixture compressed in the hot compression step so as to form the glass seal layer, wherein

the pushing speed of the terminal electrode in the hot compression step falls within a range of 5 mm/sec to 150 mm/sec inclusive; and

in the cooling step, relative movement of the terminal electrode in relation to the insulator is restricted until the temperature of the glass powder mixture drops to a temperature which is equal to or lower than a temperature obtained by adding 100° C. to a softening point of glass which constitutes the glass powder.

The term “softening point” refers to a temperature at the endothermic peak of a differential thermal curve obtained by performing a differential thermal analysis on the glass powder. Notably, the “differential thermal analysis” is an analysis performed in accordance with the thermal analysis general rule provided in JIS K0129. That is, in the analysis, glass powder and a reference substance (substance which does not change (e.g., does not melt) at the time of heating to be described later) are placed in a furnace and are heated under the same conditions, and the temperature difference between the glass powder and the reference substance is measured. Further, the “differential thermal curve” refers to a graph showing the relation between the measured temperature difference and the heating time.

The hot compression step may be performed in such a manner that, after the terminal electrode is inserted, the glass powder mixture, etc. are heated, and the terminal electrode is then pushed. Alternatively, the hot compression step may be performed in such a manner that, after the terminal electrode is inserted, the terminal electrode is pushed, while the glass powder mixture, etc. are heated. Alternatively, the hot compression step may be performed in such a manner that, after the glass powder mixture, etc. are heated, the terminal electrode is inserted and then pushed. Alternatively, the hot compression step may be performed in such a manner that, after the glass powder mixture, etc. are heated, the terminal electrode is inserted, and the terminal electrode is pushed, while the glass powder mixture is heated further. That is, the “pushing the terminal electrode in a heated state” refers to a process of pushing the terminal electrode in a state where the glass powder mixture is sufficiently heated (to a degree such that the terminal electrode can be pushed and advanced), and the operation of pushing the terminal electrode may be performed, while the glass powder mixture, etc. are heated, or after the glass powder mixture, etc. are heated. Further, the operation of inserting the terminal electrode may be performed before the heating of the glass powder mixture, etc., during the heating, or after the heating.

In the case where the axial hole of the insulator has a diameter of 4 mm or less and hot pressing is performed with the pushing speed of the terminal electrode set to 5 mm/sec or greater as in Configuration 1, the residual stress within the compressed glass powder mixture increases considerably, and lifting of the terminal electrode from the insulator may occur.

In contrast, according to Configuration 1, in the cooling step, relative movement of the terminal electrode in relation to the insulator is restricted until the temperature of the glass powder mixture drops to a temperature which is equal to or lower than a temperature (hereinafter referred to the “target temperature”) obtained by adding 100° C. to the softening point of glass which constitutes the glass powder. That is, relative movement of the terminal electrode in relation to the insulator is restricted until the glass which has been heated to a high temperature in the hot compression step to have a relative low viscosity is sufficiently cooled and has a sufficiently large viscosity. Thus, in the high temperature state where the viscosity of the glass which constitutes the glass powder is relatively low and, due to the residual stress, the glass powder mixture tends to deform (expand) in a direction opposite the pushing direction (a direction in which the terminal electrode is pushed out), relative movement of the terminal electrode in relation to the insulator is restricted. Therefore, lifting of the terminal electrode can be prevented more reliably. Meanwhile, in a state where the glass has been cooled to a relatively low temperature, the glass which constitutes the glass powder has a sufficient viscosity, whereby the glass having high viscosity suppresses the deformation (expansion) of the glass powder mixture in the direction opposite the pushing direction. As a result, even when the restriction on relative movement of the terminal electrode is canceled, lifting of the terminal electrode from the insulator can be prevented effectively.

Further, according to Configuration 1, relative movement of the terminal electrode in relation to the insulator is required to be restricted only during a high temperature period during which the temperature of the glass powder mixture drops to the target temperature. When the temperature of the glass powder mixture drops below the target temperature, the restriction on relative movement of the terminal electrode can be canceled. Therefore, production efficiency can be improved, as compared with the case where the restriction on relative movement of the terminal electrode is continued until the glass which constitutes the glass powder solidifies.

Notably, when the pushing speed of the terminal electrode exceeds 150 mm/sec, the residual stress within the compressed glass powder mixture increases excessively. Therefore, even when relative movement of the terminal electrode in relation to the insulator is restricted until the temperature of the glass powder mixture reaches the target temperature, lifting of the terminal electrode cannot be suppressed.

Incidentally, from the viewpoint of further improving production efficiency, preferably, the restriction on relative movement of the terminal electrode is canceled when the temperature of the glass powder mixture is relatively high. Accordingly, preferably, the restriction on relative movement of the terminal electrode is canceled when the temperature of the glass powder mixture falls within a range of the target temperature to a temperature obtained by subtracting 150° C. from the target temperature. More preferably, the restriction on relative movement of the terminal electrode is canceled when the temperature of the glass powder mixture falls within a range of the target temperature to a temperature obtained by subtracting 100° C. from the target temperature.

In addition, the cooling in the cooling step may be quick cooling performed by use of a water-cooled cooler, a fan, or the like, or self-cooling. However, from the viewpoint of preventing cracking or the like of the insulator due to thermal shock, self-cooling is preferred.

Configuration 2. In accordance with another aspect of the present invention, there is provided a method of manufacturing a spark plug according to the above-described Configuration 1, further characterized in that the maximum outer diameter of the glass seal layer is 3 mm or less.

When the maximum outer diameter of the glass seal layer is further reduced to 3 mm or less (for example, 2.5 mm or less) as in Configuration 2, the residual stress within the glass powder mixture may increase further. However, even when an insulator whose axial hole has a further reduced diameter is employed, through employment of Configuration 1, lifting of the terminal electrode from the insulator can be prevented more reliably. That is, employment of Configuration 1 is meaningful for manufacture of a spark plug having a glass seal layer having a further reduced maximum outer diameter.

Configuration 3. In accordance with another aspect of the present invention, there is provided a method of manufacturing a spark plug according to the above-described Configurations 1 or 2, further characterized in that the pushing speed of the terminal electrode in the hot compression step is 10 mm/sec or greater.

According to Configuration 3, production efficiency can be improved further by means of further increasing the pushing speed of the terminal electrode in the hot compression step to 10 mm/sec or greater. Meanwhile, as a result of increasing the pushing speed of the terminal electrode, concern arises for a further increase in the residual stress within the glass powder mixture.

However, even when the pushing speed of the terminal electrode is increased further, through employment of Configuration 1, lifting of the terminal electrode from the insulator can be prevented more reliably. That is, employment of Configuration 1 is meaningful for the case where the pushing speed of the terminal electrode is increased further.

Configuration 4. In accordance with another aspect of the present invention, there is provided a method of manufacturing a spark plug according to any of the above-described Configurations 1 to 3, further characterized in that the pushing speed of the terminal electrode in the hot compression step is 100 mm/sec or greater.

According to Configuration 4, production efficiency can be improved further, while lifting of the terminal electrode from the insulator can be prevented more reliably.

Configuration 5. In accordance with another aspect of the present invention, there is provided a method of manufacturing a spark plug according to any of the above-described Configurations 1 to 4, further characterized in that a resistor is provided in the axial hole such that the glass seal layer is located between the resistor and the terminal electrode.

In order to suppress radio noise generated as a result of operation of an engine, a resistor may be provided between a first glass seal layer (corresponding to the glass seal layer in each of the above-described configurations), which provides a seal between the insulator and the terminal electrode, and a second glass seal layer, which provides a seal between the insulator and the center electrode, as in Configuration 5. The resistor is formed from a resistor composition which contains an electrically conductive material, ceramic grains, etc. and which is charged into the axial hole along with the glass powder mixture, and is sintered and formed through heating and compressing processes. When the resistor composition is compressed, the compressing load applied by the terminal electrode must be increased further. Therefore, the residual stresses within the glass powder mixture and the resistor composition increases further, and greater concern arises for lifting of the terminal electrode from the insulator.

However, even when a resistor is provided as in Configuration 5, through employment of Configuration 1, etc., lifting of the terminal electrode can be prevented more reliably. That is, through employment of the above-described Configuration 1, etc., when the restriction on relative movement of the terminal electrode in relation to the insulator is cancelled, the glass powder mixture present between the terminal electrode and the resistor has a sufficient viscosity. Therefore, it is possible to effectively prevent the glass powder mixture from deforming in the direction opposite the pushing direction, which deformation would otherwise occur due to the residual stresses within the resistor composition and the glass powder mixture, to thereby prevent lifting of the terminal electrode from the insulator more reliably.

Configuration 6. In accordance with another aspect of the present invention, there is provided a method of manufacturing a spark plug according to any of the above-described Configurations 1 to 5, further characterized in that, in the cooling step, relative movement of the terminal electrode in relation to the insulator is restricted until the temperature of the glass powder mixture drops to a temperature which is equal to or lower than a temperature obtained by adding 50° C. to the softening point of glass which constitutes the glass powder.

According to Configuration 6, relative movement of the terminal electrode in relation to the insulator is restricted until the glass which constitutes the glass powder is cooled further and has a higher viscosity. As a result, lifting of the terminal electrode from the insulator can be prevented more reliably.

Configuration 7. In accordance with still another aspect of the present invention, there is provided a method of manufacturing a spark plug according to any of the above-described Configurations 1 to 6, further characterized in that, in the cooling step, relative movement of the terminal electrode in relation to the insulator is restricted until the temperature of the glass powder mixture drops to a temperature which is equal to or less than the softening point of glass which constitutes the glass powder.

According to Configuration 7, relative movement of the terminal electrode in relation to the insulator is restricted until the glass which constitutes the glass powder has a much higher viscosity. As a result, lifting of the terminal electrode from the insulator can be prevented further more reliably.

Configuration 8. In accordance with yet another aspect of the present invention, there is provided a method of manufacturing a spark plug according to any of the above-described Configurations 1 to 7, further characterized in that, in the cooling step, relative movement of the terminal electrode in relation to the insulator is restricted until the temperature of the glass powder mixture drops to a temperature which is equal to or lower than a temperature obtained by subtracting 50° C. from the softening point of glass which constitutes the glass powder.

According to Configuration 8, relative movement of the terminal electrode in relation to the insulator is restricted until the glass which constitutes the glass powder has an extremely higher viscosity. As a result, lifting of the terminal electrode can be prevented more effectively.

### BRIEF DESCRIPTION OF THE DRAWINGS

FIG. 1 is a partially sectioned front view showing the structure of a spark plug according to a first embodiment.

FIGS. 2(a) to (c) are sectional views, each showing one step of a method of manufacturing a spark plug according to the first embodiment.

FIG. 3 is a partially sectioned front view showing the structure of a spark plug according to a second embodiment.

FIGS. 4(a) to (c) are sectional views, each showing one step of a method of manufacturing the spark plug according to the second embodiment.

FIG. 5 is a partially sectioned front view showing a spark plug in a state where the terminal electrode is lifted from the insulator.

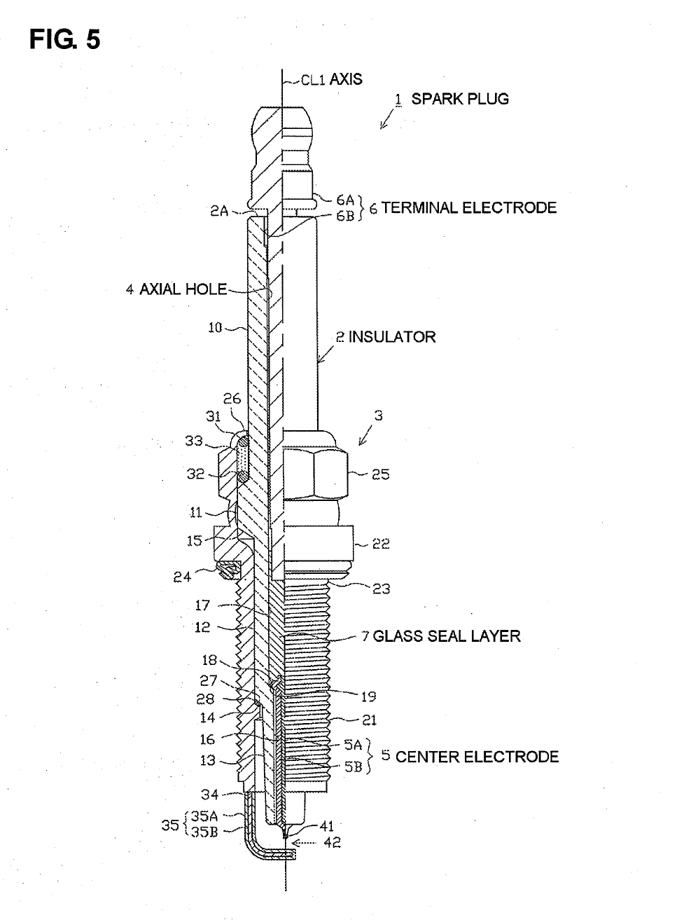

### DETAILED DESCRIPTION OF PREFERRED EMBODIMENTS

Embodiments will now be described with reference to the drawings.

### First Embodiment

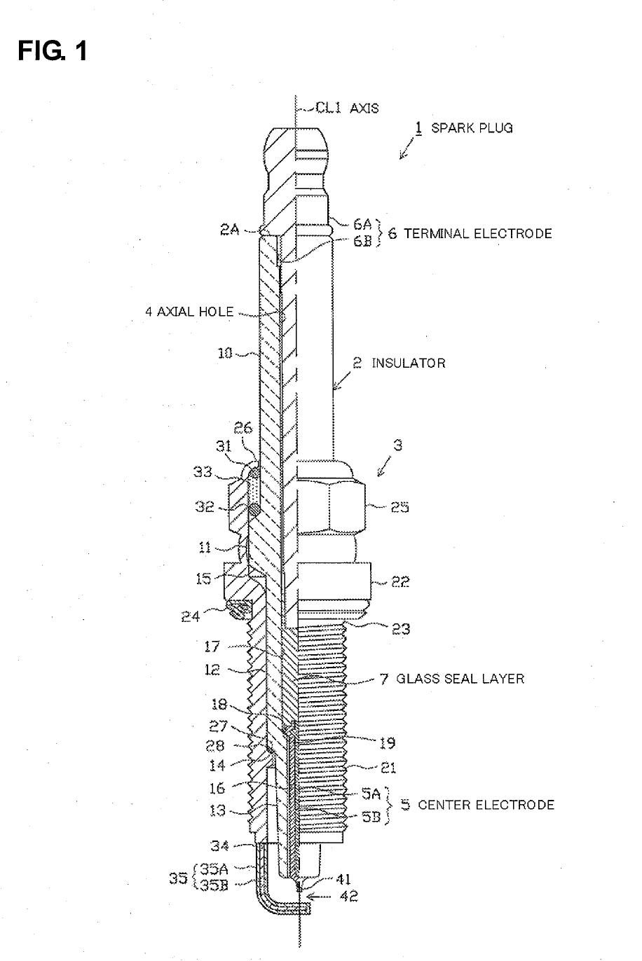

FIG. 1 is a partially sectioned front view showing a spark plug 1. Notably, in FIG. 1, the spark plug 1 is depicted in such a manner that the direction of an axis CL1 of the spark plug 1 coincides with the vertical direction in FIG. 1. Further, in the following description, the lower side of FIG. 1 will be referred to as the front end side of the spark plug 1, and the upper side of FIG. 1 will be referred to as the rear end side of the spark plug 1.

The spark plug 1 is composed of a tubular insulator 2, and a tubular metallic shell 3 which holds the insulator 2.

The insulator 2 is formed from alumina or the like through firing. The insulator 2 includes a rear-end-side trunk portion 10 formed on the rear end side A larger diameter portion 11 projects radially outward on the front end side of the rear-end-side trunk portion 10. An intermediate trunk portion 12 is formed on the front end side of the larger diameter portion 11 and has a diameter smaller than that of a larger diameter portion 11 A leg portion 13 is formed on the front end side of the intermediate trunk portion 12 and has a diameter smaller than that of the intermediate trunk portion 12. Of the insulator 2, the larger diameter portion 11, the intermediate trunk portion 12, and the greater part of the leg portion 13 are accommodated within the metallic shell 3. A first step portion 14 is formed at a connection portion between the leg portion 13 and the intermediate trunk portion 12. The first step portion 14 is tapered such that its diameter decreases toward the front end side. The insulator 2 is engaged with the metallic shell 3 at the first step portion 14. Further, a second step portion 15 is formed at a connection portion between the large diameter portion 11 and the intermediate trunk portion 12. The second step portion 15 is tapered such that its diameter decreases toward the front end side.

The insulator 2 has an axial hole 4 which extends axially through the insulator 2 along the axis CL1. The axial hole 4 has a small diameter portion 16 located at the front end portion. A large diameter portion 17 is formed rearward of the small diameter 16 and has a diameter greater than that of the small diameter portion 16. A tapered axial hole step portion 18 is formed between the small diameter portion 16 and the large diameter portion 17.

In addition, a center electrode 5 is inserted into and fixed to the front end portion (the small diameter portion 16) of the axial hole 4. More specifically, the center electrode 5 has an enlarged portion 19 formed at the rear end thereof. The enlarged portion 19 projects radially outward from the center electrode 5. The center electrode 5 is fixed in a state where the enlarged portion 19 is engaged with the axial hole step portion 18. The center electrode 5 is comprised of an inner layer 5A formed of copper or a copper alloy, and an outer layer 5B formed of a nickel alloy whose predominant component is nickel (Ni). The center electrode 5 assumes a rod-like shape (cylindrical columnar shape) as a whole. The distal end surface of the center electrode 5 is formed flat, and projects from the front end of the insulator 2.

A front end portion of a terminal electrode 6, formed of a metallic material, is inserted into a rear end portion (the large diameter portion 17) of the axial hole 4. More specifically, the terminal electrode 6 includes a terminal portion 6A, to which a plug cap (not shown) or the like for electric power supply is attached. An extending portion 6B extends frontward from the terminal portion 6A and has a diameter smaller than that of the terminal portion 6A. The extending portion 6B is inserted into and fixed to the axial hole 4 in a state where the terminal portion 6A is in contact with a rear end surface 2A of the insulator 2.

Further, a glass seal layer 7 is provided in the axial hole 4 (the large diameter portion 17) between the center electrode 5 and the terminal electrode 6 so as to fix the center electrode 5 and the terminal electrode 6 to the insulator 2 in a sealed condition. The glass seal layer 7 is formed of an electrically conductive material and establishes electrical connection between the center electrode 5 and the terminal electrode 6.

In addition, the metallic shell 3 is formed of metal such as low carbon steel and has a tubular shape. A thread portion (external thread portion) 21 for mounting the spark plug 1 onto an engine head is formed on the outer circumferential surface thereof. Further, a seat portion 22 is formed on the outer circumferential surface located on the rear end side of the thread portion 21. A ring-shaped gasket 24 is fitted into a thread neck potion 23 at the rear end of the thread portion 21. Moreover, a tool engagement portion 25 and a crimped portion 26 are provided at the rear end of the metallic shell 3. The tool engagement portion 25 has a hexagonal cross section, for engagement with a tool, such as a wrench. The tool, i.e., wrench, engages with the tool engagement portion 25 when the metallic shell 3 is mounted to the engine head. The crimped portion 26 holds the insulator 2 at the rear end portion.

A tapered shell step portion 27, with which the insulator 2 is engaged, is provided on the front end side of the inner circumferential surface of the metallic shell 3. The insulator 2 is inserted into the metallic shell 3 from its rear end side toward the front end side. In a state where the first step portion 14 of the insulator 2 is engaged with the shell step portion 27 of the metallic shell 3, a rear-end-side opening portion of the metallic shell 3 is crimped radially inward; i.e., the above-mentioned crimped portion 26 is formed, whereby the insulator 2 is fixed. Notably, an annular plate packing 28 is interposed between the first step portion 14 and the shell step portion 27. Thus, the air tightness of a combustion chamber is secured, whereby a fuel air mixture which enters the clearance between the inner circumferential surface of the metallic shell 3 and the leg portion 13 of the insulator 2 exposed to the interior of the combustion chamber is prevented from leaking to the outside.

Moreover, in order to render the sealing by the crimping more perfect, on the rear end side of the metallic shell 3, annular ring members 31 and 32 are interposed between the metallic shell 3 and the insulator 2, and powder of talc 33 is charged into the space between the ring members 31 and 32. That is, the metallic shell 3 holds the insulator 2 via the plate packing 28, the ring members 31 and 32, and the talc 33.

A ground electrode 35 formed of a nickel (Ni)-based alloy or the like is joined to a front end portion 34 of the metallic shell 3. That is, a rear end portion of the ground electrode 35 is welded to the front end portion 34 of the metallic shell 3. A front end portion of the ground electrode 35 is bent such that its side surface faces the front end of the center electrode 5. The ground electrode 35 has a double layer structure composed of an outer layer 35A and an inner layer 35B. In the present embodiment, the outer layer 35A is formed of a nickel alloy (e.g., Inconel 600 or Inconel 601, both of which are registered trademarks). The inner layer 35B is formed of pure copper or a copper ally, which is a metal having a higher heat conductivity than the above-mentioned nickel alloy.

In addition, a cylindrical columnar noble metal chip 41 formed of a noble metal alloy (e.g., a platinum alloy, an iridium alloy, or the like) is joined to the front end surface of the center electrode 5. A spark discharge gap 42 is formed between the front end surface of the noble metal chip 41 and a surface of the ground electrode 35 which surface faces the noble metal chip 41.

Since the insulator 2 of the present embodiment has a relatively small diameter, the axial hole 4 has a relatively small diameter. Specifically, the large diameter portion 17 of the axial hole 4 has a diameter of 4 mm or less, and, thus, the glass seal layer 7 formed within the large diameter portion 17 has a maximum outer diameter of 4 mm or less.

Next, a method of manufacturing the spark plug 1 configured as described above will be described. First, the metallic shell 3 is previously fabricated. That is, a cold forging operation is performed on a cylindrical columnar metal material (e.g., iron material or stainless steel material such as S17C or S25C) so as to form a through hole therein and impart a rough shape to the metal material. Subsequently, a cutting operation is performed on the metal material so as to impart a predetermined outer shape to the metal material to thereby obtain a metallic shell intermediate.

Subsequently, the ground electrode 35, formed of a nickel alloy or the like, is resistance-welded to the front end surface of the metallic shell intermediate. Since a so-called “sag” is produced as a result of the welding, the “sag” is removed. Subsequently, the thread portion 21 is formed in a predetermined region of the metallic shell intermediate by means of form rolling. Thus, the metallic shell 3 to which the ground electrode 35 has been welded is obtained. Zinc plating or nickel plating is performed on the metallic shell 3 to which the ground electrode 35 has been welded. Notably, in order to improve corrosion resistance, chromate treatment may be performed on the surface of the metallic shell 3.

The insulator 2 is formed separately from the metallic shell 3. For example, material granules for molding are prepared from material powder containing alumina (predominant component), binder, etc. A cylindrical compact is obtained by performing rubber press molding while using the material granules. Grinding is performed on the obtained compact for trimming. The trimmed compact is placed in a firing furnace and fired, whereby the insulator 2 is obtained.

Further, separately from the metallic shell 3 and the insulator 2, the center electrode 5 is manufactured. That is, a nickel alloy is forged, and the inner layer 5A formed of a copper alloy is placed at a center portion thereof in order to improve heat radiation performance. Then, the above-mentioned noble metal chip 41 is joined to the front end portion of the center electrode 5 by means of resistance welding, laser welding, or the like.

Further, through a hot press process, which is the feature of the present invention, the insulator 2, the center electrode 5, and the terminal electrode 6, which are obtained in the above-described manner, are fixed together in a sealed condition by means of the glass seal layer 7. The hot press process comprises a disposing step, a charging step, an inserting step, a hot compression step, and a cooling step.

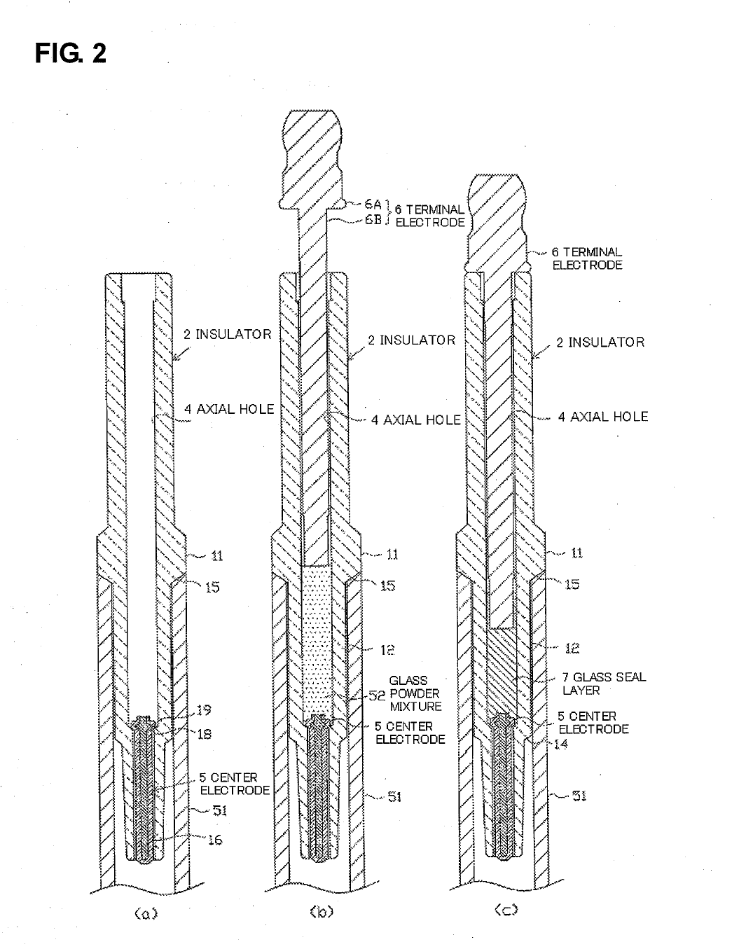

First, as shown in FIG. 2(a), the second step portion 15 is supported by a distal end surface of a support tube 51 formed of metal and having a tubular shape, whereby the insulator 2 is supported. Subsequently, in the disposing step, the center electrode 5 is inserted into and disposed in the small diameter portion 16 of the axial hole 4 in a state where the enlarged portion 19 of the center electrode 5 is engaged with the axial hole step portion 18.

Next, in the charging step, as shown in FIG. 2(b), an electrically conductive glass powder mixture 52, prepared through mixing glass powder, metal powder, etc., is charged into the axial hole 4 and is compressed in a state where the insulator 2 is supported at the second step portion 15. Specifically, after the glass powder mixture 52 is charged into the axial hole 4, the charged glass powder mixture 52 is compressed by a press pin (not shown). Notably, in the present embodiment, the glass powder is formed of an SiO2—B₂O₃—Na₂O-based ceramic material, and the softening point (glass softening point) of the ceramic material is about 700° C.

Subsequently, in the inserting step, the terminal electrode 6 is inserted into the axial hole 4.

Then, in the hot compression step, in a state where the terminal electrode 6 is pushed into the axial hole 4 from the side opposite the center electrode 5, the glass powder mixture 52, the insulator 2, etc. are heated within a firing furnace at a temperature (e.g., 950° C.), which is higher than the glass softening point by 100° C. or more, for a predetermined time (e.g., about 20 min). At that time, the pushing speed of the terminal electrode 6 is set to become not less than 5 mm/sec (e.g., not less than 10 mm/sec) but not greater than 150 mm/sec. Notably, a layer of glaze may be formed on the surface of the rear-end-side trunk portion 10 of the insulator 2 through firing simultaneously with the heating within the firing furnace, or may be formed in advance.

Notably, in the hot compression step, the terminal electrode 6 may be pushed after the glass powder mixture 52, etc. are heated. Alternatively, the terminal electrode 6 may be inserted and then pushed after the glass powder mixture 52, etc. are heated. Alternatively, the terminal electrode 6 may be inserted after the glass powder mixture 52, etc. are heated, and be pushed, while the glass powder mixture 52 is heated further. That is, the operation of pushing the terminal electrode 6 may be performed, while the glass powder mixture 52, etc. are heated, or after the glass powder mixture 52, etc. are heated. Further, the operation of inserting the terminal electrode 6 may be performed before the heating of the glass powder mixture 52, etc., during the heating, or after the heating.

Next, in the cooling step, the heated glass powder mixture 52, etc. are self-cooled. This self-cooling is performed in a state where the terminal electrode 6 is held by means of holding means (not shown) so as to restrict relative movement of the terminal electrode 6 in relation to the insulator 2, until the temperature of the glass powder mixture 52 drops to a temperature (called “release temperature”; 800° C. in the present embodiment) equal to or lower than a temperature (called “target temperature”; 800° C. in the present embodiment) obtained by adding 100° C. to the glass softening point. When the temperature of the glass powder mixture 52 drops to a temperature lower than the release temperature, the terminal electrode 6 is released from the held state. After that, the softened glass which constitutes the glass powder solidifies through further progress of the self-cooling, whereby the glass seal layer 7 is formed as shown in FIG. 2(c). As a result, the center electrode 5 and the terminal electrode 6 are fixed to the insulator 2 in a sealed condition.

After that, the insulator 2 carrying the center electrode 5, the glass seal layer 7, etc., which have been manufactured in the above-described manner, and the metallic shell 3 having the ground terminal 35 are assembled together. More specifically, the insulator 2 is fixed by means of crimping radially inward the rear-end-side opening portion of the metallic shell 3 having a relatively small wall thickness; that is, forming the above-described crimped portion 26.

Finally, the ground electrode 35 is bent so as to adjust the spark discharge gap 42 between the ground electrode 35 and the noble metal chip 41 provided at the front end of the center electrode 5.

Through the above-described series of steps, the spark plug 1 having the above-described structure is manufactured.

According to the present embodiment, in the cooling step, cooling is performed such that relative movement of the terminal electrode 6 in relation to the insulator 2 is restricted until the temperature of the glass powder mixture 52 drops to a temperature equal to or lower than the temperature (target temperature) obtained by adding 100° C. to the softening point of glass which constitutes the glass powder. That is, relative movement of the terminal electrode 6 in relation to the insulator 2 is restricted until the glass which has been heated to a high temperature in the hot compression step to have a relative low viscosity is sufficiently cooled and has a sufficiently large viscosity. Thus, in the high temperature state where the viscosity of the glass which constitutes the glass powder is relatively small and, due to the residual stress, the glass powder mixture 52 tends to deform (expand) in a direction opposite the pushing direction, relative movement of the terminal electrode 6 in relation to the insulator 2 is restricted. Therefore, lifting of the terminal electrode 6 can be prevented more reliably. Meanwhile, in a state where the glass has been cooled to a relatively low temperature, the glass which constitutes the glass powder has a sufficient viscosity, whereby the glass having high viscosity suppresses the deformation (expansion) of the glass powder mixture 52 in the direction opposite the pushing direction. As a result, even when the restriction on relative movement of the terminal electrode 6 is canceled, lifting of the terminal electrode 6 from the insulator 2 can be prevented effectively.

Further, in the present embodiment, the terminal electrode 6 is held only in a high temperature period in which the temperature of the glass powder mixture 52 drops to a temperature equal to or lower than the target temperature; and, when the temperature of the glass powder mixture 52 drops below the release temperature, the terminal electrode 6 is released from the held state. Therefore, production efficiency can be improved, as compared with the case where the operation of holding the terminal electrode 6 is continued until the glass which constitutes the glass powder solidifies.

Further, since the pushing speed of the terminal electrode 6 is set to be equal to 150 mm/sec or smaller, it is possible to prevent the generation of an excessively large residual stress within the glass powder mixture 52 after the hot compression. Therefore, lifting of the terminal electrode can be suppressed more reliably.

In addition, in the cooling step, cooling is effected by means of self-cooling, cracking or the like of the insulator 2 due to an abrupt change in temperature can be prevented more reliably.

### Second Embodiment

Next, a second embodiment will be described with reference to the drawings. Structural features different from those of the first embodiment will mainly be described.

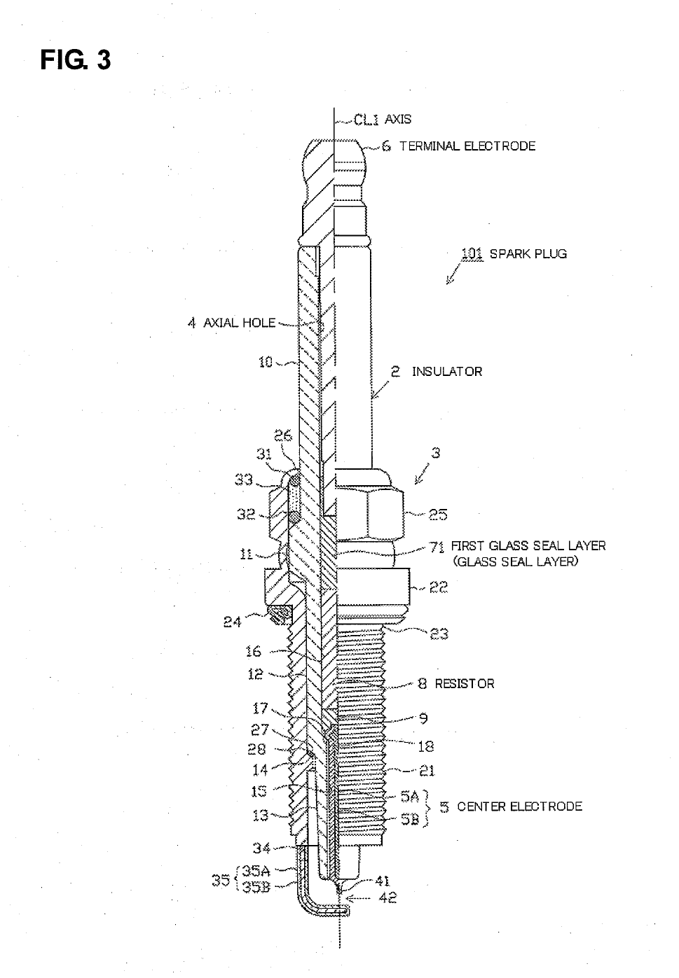

As shown in FIG. 3, a spark plug 101 according to the second embodiment includes a resistor 8 which is provided within the axial hole 4 so as to suppress radio noise generated as a result of operation of an engine. More specifically, within the axial hole 4, there are provided a first glass seal layer 71 (corresponding to the glass seal layer) which fixes the insulator 2 and the terminal electrode 6 together in a sealed state, and a second glass seal layer 9 which fixes the insulator 2 and the center electrode 5 together in a sealed state. The resistor 8 is provided between the two glass seal layers 71 and 9. Notably, although the volume of the first glass seal layer 71 is a predetermined number of times (e.g., 1.5 times to 3 times) the volume of the second glass seal layer 9, the total volume of the first glass seal layer 71 and the second glass seal layer 9 is approximately equal to the volume of the glass seal layer 7 in the first embodiment. Accordingly, in the second embodiment, the volume of the charged substances located between the center electrode 5 and the terminal electrode 6 is greater than that in the first embodiment by an amount corresponding to the volume of the resistor 8.

Next, a method of manufacturing the spark plug 101 having the resistor 8 will be described. In particular, a hot press process for forming the resistor 8, etc. will be described.

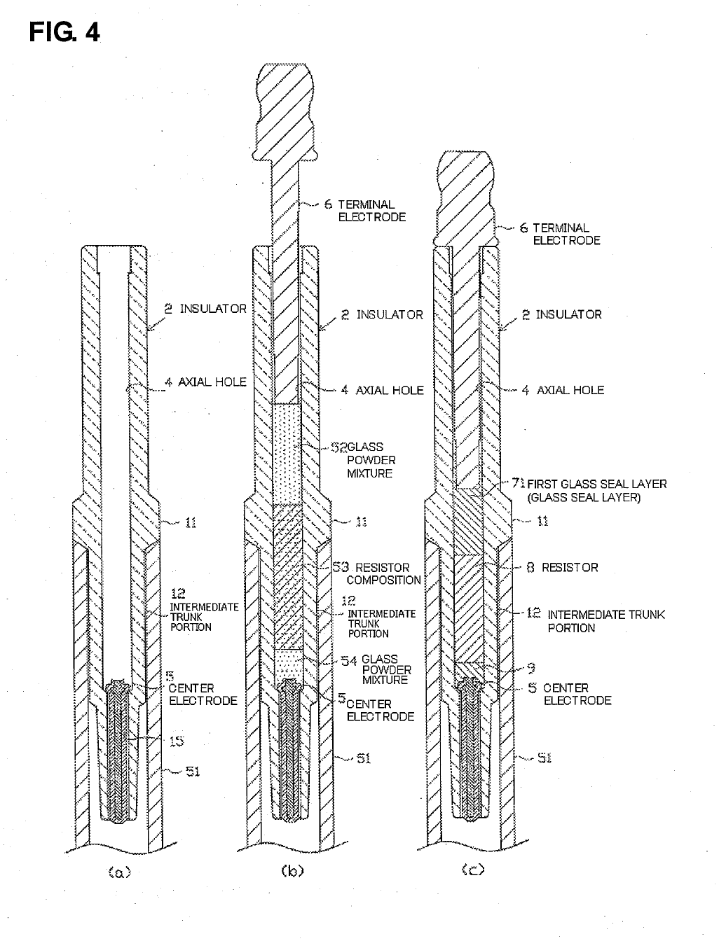

First, as shown in FIG. 4(a), in the disposing step, the center electrode 5 is disposed in the axial hole 4. Subsequently, in the charging step, as shown in FIG. 4(b), glass powder mixtures 52 and 54, and a resistor composition 53 formed of an electrically conductive material (e.g., carbon black), ceramic grains (e.g., glass grains) are charged into the axial hole 4 and compressed. More specifically, the glass powder mixture 54 is charged into the axial hole 4, and the charged glass powder mixture 54 is compressed by the above-described press pin. Next, the resistor composition 53 is charged into the axial hole 4, and is subjected to pre-compression in a similar manner. Further, the glass powder mixture 52 is charged and is subjected to pre-compression in a similar manner. Notably, in the present embodiment, the glass powder mixtures 52 and 54 are formed of the same material.

Subsequently, in the inserting step, the terminal electrode 6 is inserted into the axial hole 4. Then, in the hot compression step, in a state where the terminal electrode 6 is pushed into the axial hole 4 from the side opposite the center electrode 5, the glass powder mixtures 52 and 54, the resistor composition 53, etc. are heated within a firing furnace at a temperature which is higher than the glass softening point by 100° C. or more for a predetermined time. At that time, as in the case of the first embodiment, the pushing speed of the terminal electrode 6 is set to become not less than 5 mm/sec but not greater than 150 mm/sec. Since the resistor composition 53 is charged into the axial hole 4, a larger compression load is applied from the terminal electrode 6 to the glass powder mixtures 52 and the resistor composition 53.

Next, in the cooling step, self-cooling is performed in a state where relative movement of the terminal electrode 6 in relation to the insulator 2 is restricted until the temperature of the glass powder mixture 52 drops at least to a temperature (release temperature) equal to or lower than a temperature (target temperature) obtained by adding 100° C. to the glass softening point. When the temperature of the glass powder mixture 52 reaches the release temperature, the restriction on relative movement of the terminal electrode 6 is lifted. After that, through further progress of the self-cooling, the two glass seal layers 71, 9 and the resistor 8 are formed as shown in FIG. 4(c).

In the present embodiment, since the resistor 8 is provided, a larger compression load is applied from the terminal electrode 6 in the hot compression step. Therefore, larger stresses remain in the glass powder mixture 52 and the resistor composition 53, and greater concern arises for lifting of the terminal electrode 6. In view of this, in the second embodiment, relative movement of the terminal electrode 6 is restricted until the temperature of the glass powder mixture 52 drops at least to the target temperature as in the first embodiment. Therefore, when the terminal electrode 6 is released from the held state, the glass within the glass powder mixture 52 has a sufficient viscosity. As a result, it is possible to effectively prevent the glass powder mixture 52 from deforming in the direction opposite the pushing direction due to the stresses remaining in the glass powder mixture 52 and the resistor composition 53, whereby lifting of the terminal electrode 6 from the insulator 2 can be prevented more reliably. That is, the operation of restricting relative movement of the terminal electrode 6 until the temperature of the glass powder mixture 52 drops at least to the target temperature in the cooling step is more meaningful for the production of the spark plug 101 which includes the resistor 8 and in which greater concern arises for lifting of the terminal electrode 6.

A defect incidence evaluation test was performed in order to confirm the effects of the above-described embodiments. The defect incidence evaluation test was performed as follows. A plurality of sample insulators each containing a terminal electrode, a glass seal layer, etc. were manufactured, as a sample group, for each combination of the maximum outer diameter of the glass seal layer (the diameter of the large diameter portion of the axial hole of the insulator), the composition of glass powder contained in the glass powder mixture, and conditions in the hot press process, including the pushing speed of the terminal electrode, and the temperature (release temperature) at which restriction on relative movement of the terminal electrode is lifted. Of the plurality of samples in the same sample group manufactured under the same conditions, samples in which the terminal electrode was lifted were specified, and the incidence of the defective of terminal electrode lifting (sealing defect incidence) was calculated. In addition, each sample group whose sealing defect incidence was 0.0% was evaluated excellent (AA) because the sample group was excellent in the effect of suppressing lifting of the terminal electrode. Also, each sample group whose sealing defect incidence was greater than 0.0% but not greater than 2.0% was evaluated fair (BB) because the sample group was slightly inferior to the above-mentioned group in terms of the effect of suppressing lifting of the terminal electrode. Further, each sample group whose sealing defect incidence was greater than 2.0% was evaluated poor (CC) because the sample group was unsatisfactory in terms of the effect of suppressing lifting of the terminal electrode. Tables 1 and 2 show the sealing defect incidence, conditions under which the samples were manufactured, etc. Notably, Composition 1 in the column for “Composition” of “Glass Powder” in Tables 1 and 2 means that the glass powder was formed of an SiO₂—B₂O₃—Na₂O-based ceramic material; Composition 2 means that the glass powder was formed of an SiO₂—B₂O₃—BaO-based ceramic material; and Composition 3 means that the glass powder was formed of a B₂O_{3—SiO}₂-based ceramic material. Further, as described in these tables, the glass softening point of Composition 1 was 700° C.; the glass softening point of Composition 2 was 750° C.; and the glass softening point of Composition 3 was 650° C. Further, in the hot compression step, heating was performed at a temperature 200° C. higher than the glass softening point. In addition, the release temperature was determined by means of measuring the temperature from the heating to the cooling by use of a workpiece for temperature measurement which includes a thermocouple embedded in the glass seal layer (first glass seal layer).

TABLE 1

| | Max. | | | | | | | |
|---|---|---|---|---|---|---|---|---|
| | outer | | | | | | | |
| | dia. | | | | | | | |
| | of | Terminal | | | | | | |
| | glass | electrode | Glass powder | | | Release | | |
| | seal | pushing | | Softening | Release | temperature − | Sealing | |
| Sample | layer | speed | | point | temperature | Softening | defect | |
| No. | (mm) | (mm/sec) | Composition | (° C.) | (° C.) | point (° C.) | incidence | Evaluation |
| 1 | 4.5 | 100 | Composition 1 | 700 | 800 | 100 | 0.0% | AA |
| 2 | 4.5 | 100 | Composition 1 | 700 | 850 | 150 | 0.0% | AA |
| 3 | 4.5 | 300 | Composition 1 | 700 | 850 | 150 | 0.0% | AA |
| 4 | 4 | 100 | Composition 1 | 700 | 850 | 150 | 1.5% | BB |
| 5 | 3 | 100 | Composition 1 | 700 | 850 | 150 | 3.0% | CC |
| 6 | 4 | 10 | Composition 1 | 700 | 850 | 150 | 0.5% | BB |
| 7 | 3 | 10 | Composition 1 | 700 | 850 | 150 | 1.0% | BB |
| 8 | 3 | 5 | Composition 1 | 700 | 850 | 150 | 0.5% | BB |
| 9 | 4 | 5 | Composition 1 | 700 | 800 | 100 | 0.0% | AA |
| 10 | 4 | 10 | Composition 1 | 700 | 800 | 100 | 0.0% | AA |
| 11 | 4 | 100 | Composition 1 | 700 | 800 | 100 | 0.0% | AA |
| 12 | 4 | 300 | Composition 1 | 700 | 800 | 100 | 0.0% | AA |
| 13 | 3 | 5 | Composition 1 | 700 | 800 | 100 | 0.0% | AA |
| 14 | 3 | 10 | Composition 1 | 700 | 800 | 100 | 0.0% | AA |
| 15 | 3 | 100 | Composition 1 | 700 | 800 | 100 | 0.0% | AA |
| 16 | 3 | 150 | Composition 1 | 700 | 800 | 100 | 0.0% | AA |
| 17 | 3 | 200 | Composition 1 | 700 | 800 | 100 | 2.5% | CC |
| 18 | 3 | 250 | Composition 1 | 700 | 800 | 100 | 3.0% | CC |
| 19 | 3 | 300 | Composition 1 | 700 | 800 | 100 | 3.5% | CC |
| 20 | 4 | 5 | Composition 1 | 700 | 750 | 50 | 0.0% | AA |
| 21 | 4 | 10 | Composition 1 | 700 | 750 | 50 | 0.0% | AA |
| 22 | 4 | 100 | Composition 1 | 700 | 750 | 50 | 0.0% | AA |
| 23 | 4 | 300 | Composition 1 | 700 | 750 | 50 | 0.0% | AA |
| 24 | 3 | 5 | Composition 1 | 700 | 750 | 50 | 0.0% | AA |
| 25 | 3 | 10 | Composition 1 | 700 | 750 | 50 | 0.0% | AA |
| 26 | 3 | 100 | Composition 1 | 700 | 750 | 50 | 0.0% | AA |
| 27 | 3 | 150 | Composition 1 | 700 | 750 | 50 | 0.0% | AA |
| 28 | 3 | 200 | Composition 1 | 700 | 750 | 50 | 1.0% | BB |
| 29 | 3 | 250 | Composition 1 | 700 | 750 | 50 | 2.5% | CC |
| 30 | 3 | 300 | Composition 1 | 700 | 750 | 50 | 3.0% | CC |

TABLE 2

| | Max. | | | | | | | |
|---|---|---|---|---|---|---|---|---|
| | outer | | | | | | | |
| | dia. | | | | | | | |
| | of | Terminal | | | | | | |
| | glass | electrode | Glass powder | | | Release | | |
| | seal | pushing | | Softening | Release | temperature − | Sealing | |
| Sample | layer | speed | | point | temperature | Softening | defect | |
| No. | (mm) | (mm/sec) | Composition | (° C.) | (° C.) | point (° C.) | incidence | Evaluation |
| 31 | 4 | 5 | Composition 1 | 700 | 700 | 0 | 0.0% | AA |
| 32 | 4 | 10 | Composition 1 | 700 | 700 | 0 | 0.0% | AA |
| 33 | 4 | 100 | Composition 1 | 700 | 700 | 0 | 0.0% | AA |
| 34 | 4 | 300 | Composition 1 | 700 | 700 | 0 | 0.0% | AA |
| 35 | 3 | 5 | Composition 1 | 700 | 700 | 0 | 0.0% | AA |
| 36 | 3 | 10 | Composition 1 | 700 | 700 | 0 | 0.0% | AA |
| 37 | 3 | 100 | Composition 1 | 700 | 700 | 0 | 0.0% | AA |
| 38 | 3 | 150 | Composition 1 | 700 | 700 | 0 | 0.0% | AA |
| 39 | 3 | 200 | Composition 1 | 700 | 700 | 0 | 0.0% | AA |
| 40 | 3 | 250 | Composition 1 | 700 | 700 | 0 | 1.5% | BB |
| 41 | 3 | 300 | Composition 1 | 700 | 700 | 0 | 2.5% | CC |
| 42 | 4 | 5 | Composition 1 | 700 | 650 | −50 | 0.0% | AA |
| 43 | 4 | 10 | Composition 1 | 700 | 650 | −50 | 0.0% | AA |
| 44 | 4 | 100 | Composition 1 | 700 | 650 | −50 | 0.0% | AA |
| 45 | 4 | 300 | Composition 1 | 700 | 650 | −50 | 0.0% | AA |
| 46 | 3 | 5 | Composition 1 | 700 | 650 | −50 | 0.0% | AA |
| 47 | 3 | 10 | Composition 1 | 700 | 650 | −50 | 0.0% | AA |
| 48 | 3 | 100 | Composition 1 | 700 | 650 | −50 | 0.0% | AA |
| 49 | 3 | 150 | Composition 1 | 700 | 650 | −50 | 0.0% | AA |
| 50 | 3 | 200 | Composition 1 | 700 | 650 | −50 | 0.0% | AA |
| 51 | 3 | 250 | Composition 1 | 700 | 650 | −50 | 0.0% | AA |
| 52 | 3 | 300 | Composition 1 | 700 | 650 | −50 | 2.0% | CC |
| 53 | 3 | 100 | Composition 2 | 750 | 700 | −50 | 0.0% | AA |
| 54 | 3 | 100 | Composition 2 | 750 | 750 | 0 | 0.0% | AA |
| 55 | 3 | 100 | Composition 2 | 750 | 800 | 50 | 0.0% | AA |
| 56 | 3 | 100 | Composition 2 | 750 | 850 | 100 | 0.0% | AA |
| 57 | 3 | 100 | Composition 2 | 750 | 900 | 150 | 3.0% | CC |
| 58 | 3 | 100 | Composition 3 | 650 | 600 | −50 | 0.0% | AA |
| 59 | 3 | 100 | Composition 3 | 650 | 650 | 0 | 0.0% | AA |
| 60 | 3 | 100 | Composition 3 | 650 | 750 | 100 | 0.0% | AA |
| 61 | 3 | 100 | Composition 3 | 650 | 800 | 150 | 0.5% | CC |
| 62 | 3 | 100 | Composition 3 | 650 | 850 | 200 | 5.0% | CC |

As shown in Tables 1 and 2, it was found that, in the samples (Samples 1 to 3) in which the maximum outer diameter of the glass seal layer is 4.5 mm, lifting of the terminal electrode does not occur irrespective of differences in the release temperature and the pushing speed of the terminal electrode.

Further, through comparison among the samples (Samples 2, 4, and 5) which are identical in the terminal electrode pushing speed (100 mm/sec), the glass powder composition (Composition 1; glass softening point: 700° C.), and the release temperature (850° C.) but differ in the maximum outer diameter of the glass seal layer, it was found that lifting of the terminal electrode may occur in the samples (Samples 4 and 5) in which the maximum outer diameter of the glass seal layer is 4 mm or less. That is, the comparison reveals that, when the outer diameter of the glass seal layer is in excess of 4 mm, the residual stress within the glass powder mixture is relatively small; however, when the outer diameter of the glass seal layer is 4 mm or less, the residual stress within the glass powder mixture may become so large that the terminal electrode is lifted.

Further, through comparison between the Samples 4 and 5 and between the Samples 6 and 7, it was found that the smaller the maximum outer diameter of the glass seal layer (Samples 5 and 7), the higher the possibility of occurrence of lifting of the terminal electrode. That is, it was found that the smaller the glass seal layer, the greater the residual stress within the glass powder mixture.

In addition, through comparison among the samples (Samples 5, 7, and 8) which are identical in the maximum outer diameter of the glass seal layer (3 mm), the glass powder composition (Composition 1; glass softening point: 700° C.), and the release temperature (850° C.) but differ in the terminal electrode pushing speed (5 mm/sec, 10 mm/sec, and 100 mm/sec), it was found that the higher the pushing speed of the terminal electrode, the higher the possibility of occurrence of lifting of the terminal electrode. That is, it was found that the residual stress within the glass powder mixture increases as the terminal electrode pushing speed increases.

As described above, it was found that, in the case where the maximum outer diameter of the glass seal layer is 4 mm or less and the terminal electrode pushing speed is relatively high; i.e., 5 mm/sec or higher, a relatively large residual stress is generated, whereby lifting of the terminal electrode occurs. In addition, it was found that the smaller the maximum outer diameter of the glass seal layer and the higher the terminal electrode pushing speed, the greater the residual stress generated.

In contrast, for the samples (Samples 9 to 11, 13 to 16, 20 to 22, 24 to 27, 31 to 33, 35 to 38, 42 to 44, 46 to 49) in which the terminal electrode pushing speed was set to 150 mm/sec or less and which differ from the samples (Samples 4, 5, 6, 7, 8) in which lifting of the terminal electrode occurred, in the point that the release temperature was set to 800° C. or less (that is, in the point that the temperature obtained by subtracting the glass softening point from the release temperature was 100° C. or less), it was found that lifting of the terminal electrode does not occur in spite of the above-described conditions under which lifting of the terminal electrode is apt to occur. Conceivably, this result occurred for the following reason. That is, in the high temperature state, since relative movement of the terminal electrode was restricted, lifting of the terminal electrode did not occur. Meanwhile, when the restriction on relative movement of the terminal electrode was canceled, the glass (constituting the glass powder), which had been heated to high temperature through the hot compression step to have a relatively low viscosity, was in a sufficiently cooled state and had a sufficient viscosity. Therefore, even when the restriction on relative movement of the terminal electrode was canceled, conceivably, the high viscosity of the glass prevented the glass powder mixture from deforming and pushing up the terminal electrode, whereby lifting of the terminal electrode was able to be prevented.

Further, it was found that, among the samples (Samples 53 to 62) in which the composition of the glass powder was changed, lifting of the terminal electrode does not occur in the samples (Samples 53 to 56 and 58 to 60) in which relative movement of the terminal electrode was restricted until the temperature of the glass powder mixture dropped to a temperate obtained by adding 100° C. to the glass softening point.

Meanwhile, for the samples (Samples 3, 12, 17 to 19, 23, 28 to 30, 34, 39 to 41, 50 to 52) in which the terminal electrode pushing speed was set to be higher than 150 mm/sec, it was found that lifting of the terminal electrode may occur even when the relative movement of the terminal electrode is restricted until the temperature of the glass powder mixture drops to a temperate obtained by adding 100° C. to the glass softening point. In particular, lifting of the terminal electrode is likely to occur in the samples (Samples 17 to 19, 28 to 30, etc.) in which the maximum outer diameter of the glass seal layer was 3 mm or less and the release temperature was set to a relatively high temperature.

As described above, in the structure in which the maximum outer diameter of the glass seal layer is 4 mm or less and the terminal electrode pushing speed is set to 5 mm/sec or higher; i.e., in the structure in which lifting of the terminal electrode may occur, lifting of the terminal electrode from the insulator can be effectively prevented by means of restricting relative movement of the terminal electrode in relation to the insulator until the temperature of the glass powder mixture drops to a temperature equal to or lower than a temperature obtained by adding 100° C. to the glass softening point, and setting the terminal electrode pushing speed to 150 mm/sec or less.

In particular, the operation of restricting relative movement of the terminal electrode until the temperature of the glass powder mixture drops to a temperature equal to or lower than a temperature obtained by adding 100° C. to the glass softening point is more meaningful for the case where the glass seal layer is formed under the conditions under which lifting of the terminal electrode is more likely to occur; i.e., the maximum outer diameter of the glass seal layer is set to 3 mm or less (e.g., 2.9 mm or less, or 2.5 mm or less ) and/or the terminal electrode pushing speed is increased.

In addition, the test results regarding the samples (Samples 17 to 19, 28 to 30, 39 to 41, 50 to 52) in which the maximum outer diameter of the glass seal layer was set to 3 mm and the terminal electrode pushing speed was set to be higher than 150 mm/sec reveal that, as the release temperature is lowered, the effect of suppressing lifting of the terminal electrode is exhibited more strongly. Accordingly, from the viewpoint of prevent lifting of the terminal electrode from the insulator more reliably, it is desired to restrict relative movement of the terminal electrode until the glass powder mixture is cooled further. Accordingly, it is desired to restrict relative movement of the terminal electrode until the temperature of the glass powder mixture drops to a temperature which is equal to or lower than a temperature obtained by adding 50° C. to the glass softening point (e.g., Sample 20, etc.); it is more desired to restrict relative movement of the terminal electrode until the temperature of the glass powder mixture drops to a temperature which is equal to or lower than the glass softening point (e.g., Sample 31, etc.); and it is further more desired to restrict relative movement of the terminal electrode until the temperature of the glass powder mixture drops to a temperature which is equal to or lower than a temperature obtained by subtracting 50° C. from the glass softening point (e.g., Sample 42, etc.).

Meanwhile, from the viewpoint of further improving production efficiency, preferably, the restriction on relative movement of the terminal electrode is lifted when the temperature of the glass powder mixture is relatively high. Accordingly, preferably, the temperature of the glass powder mixture at which the restriction on relative movement of the terminal electrode is lifted is determined in consideration of the above-described conditions such that both production efficiency and yield are improved.

Notably, the present invention is not limited to the details of the above-described embodiments, and may be practiced as follows. Needless to say, other applications and modifications which are not illustrated below are possible.

(a) In the above-described embodiments, in the cooling step, the insulator 2, etc. are cooled by means of self-cooling. However, the insulator 2, etc. may be cooled by means of quick cooling performed by use of a water-cooled cooler, a fan, or the like.

(b) In the above-described second embodiment, the glass powder mixtures 52 and 54 are formed of the same material; however, the glass powder mixtures 52 and 54 may be formed of different materials. Accordingly, for example, the second embodiment may be modified such that the glass powder of the glass powder mixture 52 is formed of an SiO₂—B₂O₃—Na₂O-based ceramic material, and the glass powder of the glass powder mixture 54 is formed of an SiO₂—B₂O₃—BaO-based ceramic material. Notably, in this case, the softening point of the glass powder refers to the softening point of the glass powder (the SiO₂—B₂O₃—Na₂O-based ceramic material) of the glass powder mixture 52, which forms the first glass seal layer 71 for fixing the insulator 2 and the terminal electrode 6 together in a sealed condition.

(c) In the above-described embodiments, the noble metal chip 41 is provided at the front end of the center electrode 5; however, the noble metal chip 41 may be omitted.

(d) In the above-described embodiments, the ground electrode 35 is joined to the front end surface of the front end portion 34 of the metallic shell 3. However, the present invention can be applied to spark plugs in which a ground electrode is formed by means of cutting a portion of the metallic shell (or a portion of a front end metal piece welded to the metallic shell in advance) (for example, Japanese Patent Application Laid-Open (kokai) No. 2006-236906, etc.). Further, the ground electrode 35 may be joined to the side surface of the front end portion 34 of the metallic shell 3.

(e) In the above-described embodiments, the tool engagement portion 25 has a hexagonal cross section. However, the shape of the tool engagement portion 19 is not limited thereto. For example, the tool engagement portion may have a Bi-Hex (deformed dodecagon) shape [ISO22977: 2005(E)] or the like.

1. A method of manufacturing a spark plug which comprises
an insulator having an axial hole which extends through the insulator in an axial direction;
a center electrode provided in a front end portion of the axial hole;
a terminal electrode provided in a rear end portion of the axial hole; and
a glass seal layer formed of a glass powder mixture containing glass powder and providing a seal within the axial hole at least between the terminal electrode and the insulator, the glass seal layer having a maximum outer diameter of 4 mm or less,
the method comprising:
a disposing step of disposing a center electrode within an axial hole of an insulator;
a charging step of charging a glass powder mixture into the axial hole;
an inserting step of inserting a terminal electrode into the axial hole;
a hot compression step of pushing the terminal electrode in a heated state so as to compress the glass powder mixture; and
a cooling step of cooling the glass powder mixture compressed in the hot compression step so as to form the glass seal layer, wherein
the pushing speed of the terminal electrode in the hot compression step falls within a range of 5 mm/sec to 150 mm/sec inclusive; and
in the cooling step, relative movement of the terminal electrode in relation to the insulator is restricted until the temperature of the glass powder mixture drops to a temperature which is equal to or lower than a temperature obtained by adding 100° C. to a softening point of glass which constitutes the glass powder.

2. A method of manufacturing a spark plug according to claim 1, wherein the maximum outer diameter of the glass seal layer is 3 mm or less.

3. A method of manufacturing a spark plug according to claims 1 or 2, wherein the pushing speed of the terminal electrode in the hot compression step is 10 mm/sec or greater.

4. A method of manufacturing a spark plug according to any one of claims 1 or 2, wherein the pushing speed of the terminal electrode in the hot compression step is 100 mm/sec or greater.

5. A method of manufacturing a spark plug according to claim 1, wherein a resistor is provided in the axial hole such that the glass seal layer is located between the resistor and the terminal electrode.

6. A method of manufacturing a spark plug according to claim 1, wherein, in the cooling step, relative movement of the terminal electrode in relation to the insulator is restricted until the temperature of the glass powder mixture drops to a temperature which is equal to or lower than a temperature obtained by adding 50° C. to the softening point of glass which constitutes the glass powder.

7. A method of manufacturing a spark plug according to claim 1, wherein, in the cooling step, relative movement of the terminal electrode in relation to the insulator is restricted until the temperature of the glass powder mixture drops to a temperature which is equal to or less than the softening point of glass which constitutes the glass powder.

8. A method of manufacturing a spark plug according to claim 1, wherein, in the cooling step, relative movement of the terminal electrode in relation to the insulator is restricted until the temperature of the glass powder mixture drops to a temperature which is equal to or lower than a temperature obtained by subtracting 50° C. from the softening point of glass which constitutes the glass powder.
